(19) United States
(12) Patent Application Publication
(10) Pub. No.: US 2013/0229309 A1
(43) Pub. Date: Sep. 5, 2013

(54) BEAM ALIGNMENT METHOD UTILIZING OMNI-DIRECTIONAL SOUNDING AND USE THEREOF

(71) Applicants: Timothy THOMAS, Palatine, IL (US); Sooyoung HUR, West Lafayette, IN (US); Taejoon KIM, Berkeley, CA (US); David J. LOVE, West Lafayette, IN (US); James V. KROGMEIER, West Lafayette, IN (US)

(72) Inventors: Timothy THOMAS, Palatine, IL (US); Sooyoung HUR, West Lafayette, IN (US); Taejoon KIM, Berkeley, CA (US); David J. LOVE, West Lafayette, IN (US); James V. KROGMEIER, West Lafayette, IN (US)

(73) Assignee: Nokia Siemens Networks Oy

(21) Appl. No.: 13/409,441

(22) Filed: Mar. 1, 2012

(51) Int. Cl. H01Q 3/00

(52) U.S. Cl. 342/377; 342/368

(57) ABSTRACT

A method includes transmitting a training signal from each of N omni-directional beams corresponding to N entries in an omni-directional codebook, receiving feedback including indication(s) corresponding to an entry from a narrow beam codebook entry to use to transmit, determining, based on the indication(s), the entry from a narrow beam codebook entry to use to transmit, and transmitting a data signal using the entry from the narrow beam codebook. Another method includes receiving at a receiver a training signal including N omni-directional beams corresponding to N entries in an omni-directional codebook, determining a best entry from a narrow beam codebook to use by a transmitter in transmissions to the receiver, where the best entry is determined as a function of the received training signal including the N omni-directional beams, and transmitting to the transmitter indication(s) corresponding to the best entry of the narrow beam codebook.

### TECHNICAL FIELD

This invention relates generally to wireless communications and, more specifically, relates to beam alignment of antenna arrays.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

Network capacity is on the rise due to the ever-increasing volume of content-rich data (e.g., streaming high definition video) and other multimedia services transmitted and received on wireless networks. To accommodate this increase in capacity, network operators are examining new ways to deploy cellular networks to increase spectrum reusability. A promising deployment technique is the so-called multi-tier cell deployment, which involves integrating multiple pico cell and femto cell networks into a traditional macro cell to enhance coverage and support high data rates. For example, pico cells can be densely deployed in urban and small isolated areas to support high data rates. Such multi-tier techniques require a backhaul network to support increased traffic at high data rates.

Millimeter wave bands, particularly the unlicensed 60 GHz (gigahertz) band, are a possible solution to the problem of providing small cell backhaul in tiered cellular networks. The advantages of millimeter wave bands include the availability of many gigahertz of underutilized spectrum and the necessitated line-of-sight nature of millimeter wave communication, which helps to control interference between systems. However, millimeter wave systems require a large directional gain in order to combat their relatively high path loss compared to systems with lower frequencies.

To overcome the drawbacks of a millimeter wave backhaul system, the system requires large sizes of antennas, and beamforming techniques are applied to achieve sufficient gain to communicate in data link. When initializing the system and at other times, each node at backhaul network is needed to align beam pairs (e.g., transmission and reception antenna arrays), which is called beamforming sounding. The goal of beamforming sounding is to select codebook entries (called codewords herein) to use at each of the transmitter and receiver, e.g., to maximize received power. Many high-gain beam patterns are sent in order to select the codebook entries.

The FCC (federal communication commission) restricts the transmit power with beamforming in millimeter wave bands. In this sense, high-gain beam patterns focused in many directions are not preferred for beamforming sounding, as these may exceed the FCC power limit.

### SUMMARY

The examples in this section are merely illustrative and should not be construed as being limiting.

An exemplary method includes transmitting using a number of antennas a training signal from each of N omni-directional beams corresponding to N entries in an omni-directional codebook; receiving feedback including one or more indications corresponding to an entry from a narrow beam codebook entry to use to transmit; determining, based on the one or more indications, the entry from a narrow beam codebook entry to use to transmit; and transmitting using the number of antennas a data signal using the entry from the narrow beam codebook.

An exemplary apparatus includes means for transmitting using a number of antennas a training signal from each of N omni-directional beams corresponding to N entries in an omni-directional codebook; means for receiving feedback including one or more indications corresponding to an entry from a narrow beam codebook entry to use to transmit; means for determining, based on the one or more indications, the entry from a narrow beam codebook entry to use to transmit; and means for transmitting using the number of antennas a data signal using the entry from the narrow beam codebook.

Another exemplary apparatus includes transmitting using a number of antennas a training signal from each of N omni-directional beams corresponding to N entries in an omni-directional codebook; receiving feedback including one or more indications corresponding to an entry from a narrow beam codebook entry to use to transmit; determining, based on the one or more indications, the entry from a narrow beam codebook entry to use to transmit; and transmitting using the number of antennas a data signal using the entry from the narrow beam codebook.

An exemplary apparatus includes one or more processors and one or more memories including computer program code. The one or more memories and the computer program code are configured to, with the one or more processors, cause the apparatus to perform at least the following: transmitting using a number of antennas a training signal from each of N omni-directional beams corresponding to N entries in an omni-directional codebook; receiving feedback including one or more indications corresponding to an entry from a narrow beam codebook entry to use to transmit; determining, based on the one or more indications, the entry from a narrow beam codebook entry to use to transmit; and transmitting using the number of antennas a data signal using the entry from the narrow beam codebook.

An exemplary computer program product is disclosed that includes a computer-readable storage medium bearing computer program code embodied therein for use with a computer. The computer program code includes: code for transmitting using a number of antennas a training signal from each of N omni-directional beams corresponding to N entries in an omni-directional codebook; code for receiving feedback including one or more indications corresponding to an entry from a narrow beam codebook entry to use to transmit; code for determining, based on the one or more indications, the entry from a narrow beam codebook entry to use to transmit; and code for transmitting using the number of antennas a data signal using the entry from the narrow beam codebook.

Another exemplary method includes receiving at a receiver using a including of antennas a training signal including N omni-directional beams corresponding to N entries in an omni-directional codebook; determining a best entry from a narrow beam codebook to use by a transmitter in transmissions to the receiver, where the best entry is determined as a function of the received training signal including the N omni-directional beams; and transmitting to the transmitter one or more indications corresponding to the best entry of the narrow beam codebook.

A further exemplary apparatus includes means for receiving at a receiver using a including of antennas a training signal including N omni-directional beams corresponding to N entries in an omni-directional codebook; means for determining a best entry from a narrow beam codebook to use by a transmitter in transmissions to the receiver, where the best entry is determined as a function of the received training signal including the N omni-directional beams; and means for transmitting to the transmitter one or more indications corresponding to the best entry of the narrow beam codebook.

An additional exemplary embodiment is an apparatus that includes one or more processors and one or more memories including computer program code. The one or more memories and the computer program code are configured to, with the one or more processors, cause the apparatus to perform at least the following: receiving at a receiver using a including of antennas a training signal including N omni-directional beams corresponding to N entries in an omni-directional codebook; determining a best entry from a narrow beam codebook to use by a transmitter in transmissions to the receiver, where the best entry is determined as a function of the received training signal including the N omni-directional beams; and transmitting to the transmitter one or more indications corresponding to the best entry of the narrow beam codebook.

An exemplary computer program product is disclosed that includes a computer-readable storage medium bearing computer program code embodied therein for use with a computer. The computer program code includes: code for receiving at a receiver using a including of antennas a training signal including N omni-directional beams corresponding to N entries in an omni-directional codebook; code for determining a best entry from a narrow beam codebook to use by a transmitter in transmissions to the receiver, where the best entry is determined as a function of the received training signal including the N omni-directional beams; and code for transmitting to the transmitter one or more indications corresponding to the best entry of the narrow beam codebook.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram of an exemplary system in which the exemplary embodiments may be practiced;

FIG. 2 is a block diagram of a transmitter and receiver for performing a beam alignment method utilizing omni-directional sounding;

FIG. 3 is an example of two shifted omni-directional beams used for codebook design;

FIG. 4 is a block diagram of a flowchart performed by a transmitter of a beam alignment method utilizing omni-directional sounding and use thereof; and

FIG. 5 is a block diagram of a flowchart performed by a receiver of a beam alignment method utilizing omni-directional sounding and use thereof.

### DETAILED DESCRIPTION OF THE DRAWINGS

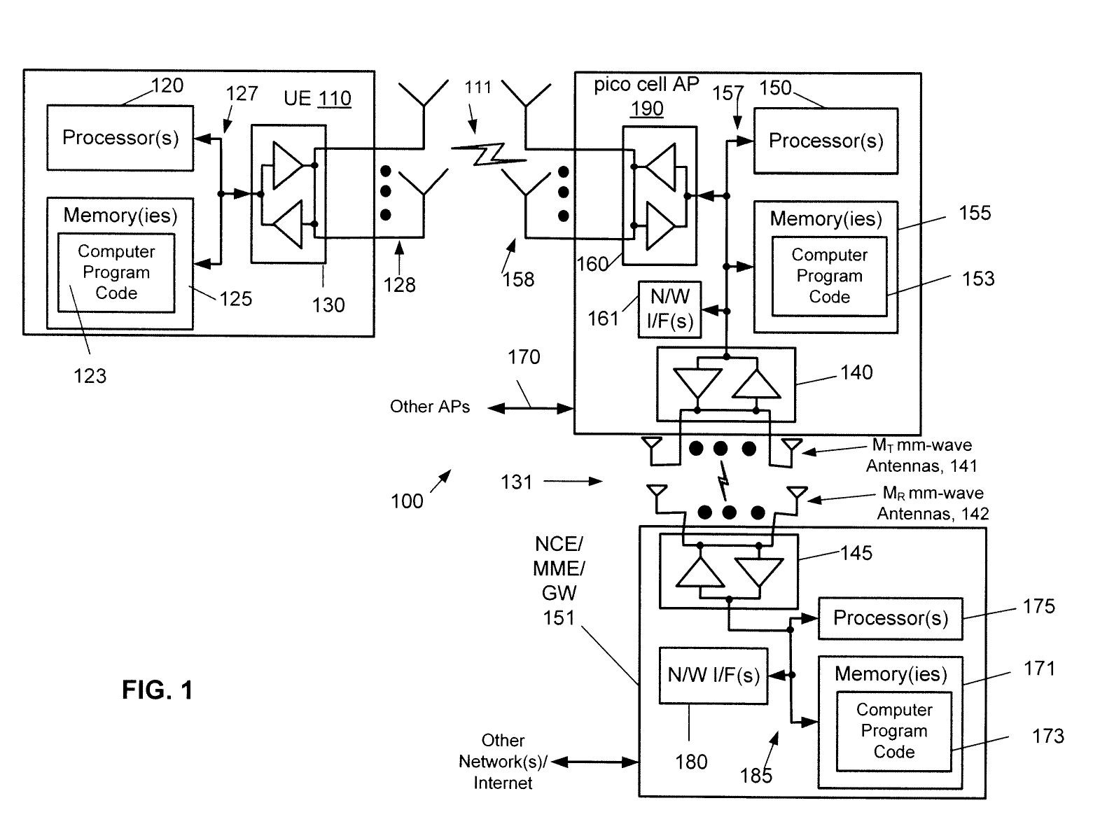

Before proceeding with additional descriptions of problems with current beam alignment methods, reference is made to FIG. 1, which shows a block diagram of an exemplary system in which the exemplary embodiments may be practiced. In FIG. 1, a UE (user equipment) 110 is in wireless communication with a network 100 via a corresponding link 111. There may be multiple UEs 110 connected to the network 100, although only one UE 110 is shown. The user equipment 110 includes one or more processors 120, one or more memories 125, and one or more transceivers 130 interconnected through one or more buses 127. The one or more transceivers 130 are connected to one or more antennas 128. The one or more memories 125 include computer program code 123. The one or more memories 125 and the computer program code 123 are configured to, with the one or more processors 120, cause the user equipment 110 to perform one or more of the operations as described herein. The UE 110 communicates with a pico cell AP (access point) 190 via link 111.

The AP 190 includes one or more processors 150, one or more memories 155, one or more network interfaces (N/W I/F(s)) 161, one or more transceivers 160, and a transceiver 140, all interconnected through one or more buses 157. The one or more transceivers 160 are connected to one or more antennas 158. The one or more memories 155 include computer program code 153. The one or more memories 155 and the computer program code 153 are configured to, with the one or more processors 150, cause the eNB 190 to perform one or more of the operations as described herein. The one or more network interfaces 161 communicate using, e.g., the links 170 and 131. Two or more eNBs 190 communicate using, e.g., link 170. The link 170 may be wired or wireless or both and may implement, e.g., an X2 interface. The AP 190 may control a pico cell or other type of wireless cell (e.g., femto, macro, or the like). The AP 190 may also be a remote radio head (RRH) controlled, e.g., by an eNodeB (an evolved NodeB, which is a base station for LTE, long term evolution). The AP 190 may also be an eNodeB. The transceiver 140 is connected to M_{T} mm-wave antennas 141 and communicates over backhaul link 131 with the NCE 151.

The network 100 may include a network control element (NCE) 151 that may include MME/SGW (mobility management entity/serving gateway) functionality, and which provides connectivity with a further network, such as a telephone network and/or a data communications network (e.g., the Internet). The eNB 190 is coupled via the backhaul link 131 to the NCE 151. The link 131 may be implemented using, e.g., an S1 interface. The NCE 151 includes one or more processors 175, one or more memories 171, and one or more network interfaces (N/W UF(s)) 180, and transceiver 145, all interconnected through one or more buses 185. The one or more memories 171 include computer program code 173. The one or more memories 171 and the computer program code 173 are configured to, with the one or more processors 175, cause the NCE 151 to perform one or more operations. The transceiver 140 is connected to M_{R} mm-wave antennas 142 and communicates over backhaul link 131 with the AP 190.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 150, and 175 may be of any type suitable to the local technical environment, and may include one or more of general purpose computers, special purpose computers, microprocessors, digital signal processors (DSPs) and processors based on a multi-core processor architecture, as non-limiting examples.

Returning now to a discussion of millimeter wave systems, use of such systems is beneficial for the following reasons. As described above, there is a need to address exponential growth in data traffic. One study suggested a forty times traffic growth expected by 2015 relative to 2010 and another study suggested a 1000 times growth by 2020. 5G (fifth generation) cellular will require 10 times the data rates of 4G rates and this data rate will be very difficult to achieve below 6 GHz. There is a lot of spectrum available at mm-wave (millimeter wave), about 20 GHz. For instance, there is 7 GHz available at 60 GHz, and 13 GHz available from 71-95 GHz. Data rates are possible up to around 30 Gbps (gigabits per second) and there is potential for common worldwide licensed allocation. Additionally, mm-wave frequencies are ideal for small cell (<200 meter range). However, a challenge includes link budget but this challenge may be met by large antenna arrays (16 elements) on both ends (e.g., transmitter and receiver). Fortunately the small wavelength at mm-wave makes manufacturing large arrays feasible. However, these large arrays need an efficient alignment procedure which in addition, does not create unwanted interference to other mm-wave links in the vicinity.

It should be noted that in addition to outdoor mm-wave backhaul and access, mm-wave could also be used for indoor systems. To obtain a reliable link at mm-wave for both indoor access, outdoor access, and outdoor backhaul, large array gains are needed. As stated above, a large number of antennas is feasible at mm-wave due to small wavelength: a 4×4 array at 60 GHz (λ/2 spacing) can fit in 1.5×1.5 cm² (square centimeters). Very narrow beams obtained with large antenna arrays make beam alignment at both the receiver and transmitter challenging. Scanning narrow beams at the transmitter can spread strong interference in undesired directions causing unwanted interference to other links. Further, there might be FCC limits that will be violated by scanning a narrow beam at the transmitter in multiple directions in a short period of time. Thus, a problem is how to align the transmitter and receiver antenna arrays without causing strong interference at undesired directions.

To avoid the problems of conventional beamforming sounding (also called beam alignment) for millimeter wave systems, efficient beamforming sounding methods utilizing omni-directional beam patterns are proposed herein. Instead of high-gain directional beams, the wireless backhaul system estimates the best narrow beam to be used at the transmitter with omni-directional beams and linear construction. The techniques for low probability of intercept (LPI) radar systems in D. Lawrence, “Low Probability of Intercept Antenna Array Beamforming,” IEEE Transactions on Antennas and Propagation, September 2010, are adapted for use herein. Disclosed herein are a beam design of omni-directional sounding method and a method of construction to high-gain beams.

It is noted that, in general, there is a correlation between narrowing a beam by increasing the number of antennas which then increases the gain. It is actually the increasing of the number of antennas that increases the gain, but at the same time increasing the number of antennas narrows the beam. For these reasons, the terms “high-gain” beam and “narrow” beam are used interchangeably herein.

System Model and Assumptions

Millimeter wave channels are typically characterized by a strong LOS (line of sight) component and a few dominant multipath components, so that propagation is accurately predicted by ray tracing with a small number of rays, which consider the outdoor environment. Following these, the geometry of pico cell deployments is modeled with backhaul links of several tens of meters in length and antennas mounted on street lamp posts surrounded by tall buildings forming an urban canyon.

It is assumed that outdoor millimeter wave beamforming systems are equipped with tens of array elements at both transmitter and receiver (e.g., 64-elements or even more) in order to achieve sufficient directional gain. These large size arrays are practical for millimeter waves since the antenna array form factor can be kept reasonably small.

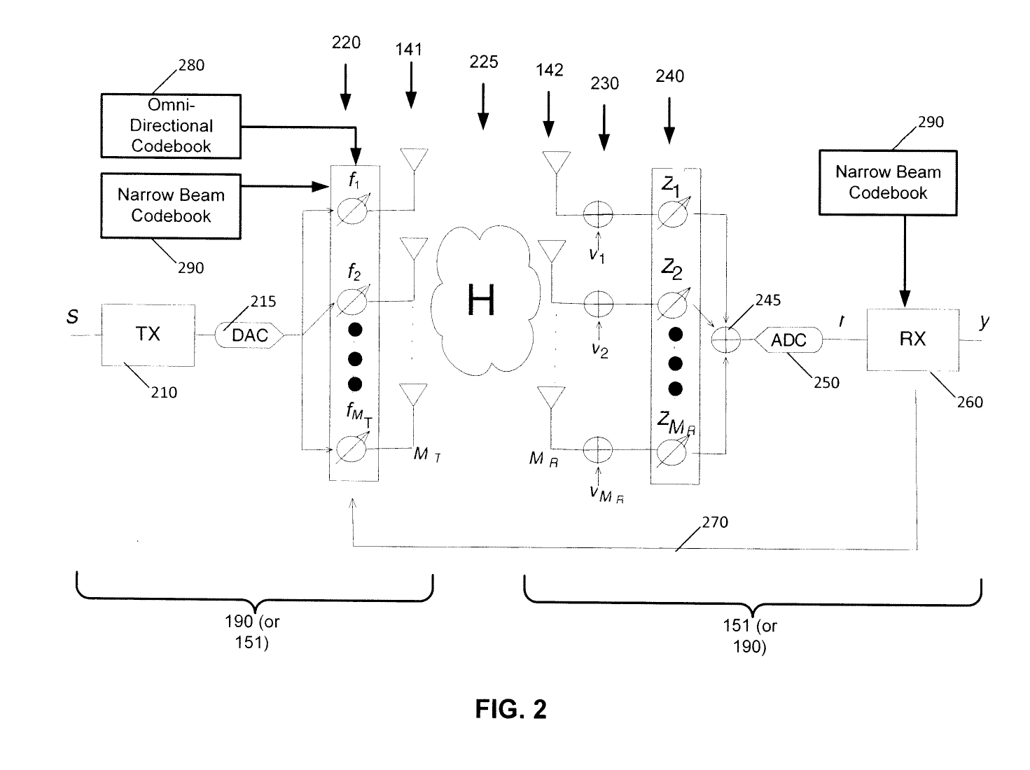

Millimeter wave systems typically use analog beamforming. See, e.g., J. Nsenga, et al., “Joint transmit and receive analog beamforming in 60 GHz MIMO multipath channels,” in ICC'09: Proceedings of the 2009 IEEE international conference on Communications, June 2009. The analog beamforming approach is followed herein, because the large numbers of antenna array elements would require considerable power and complexity if ADC/DAC (analog to digital conversion and digital to analog conversion) were utilized in the baseband/IF (intermediate frequency) chains of individual elements. In addition, if individual channel elements from each transmit antenna to each receive antenna were to be estimated, a complex and overhead-costly training procedure would be required. The transmitter and receiver block diagram is shown in FIG. 2.

In the example of FIG. 2, it can be assumed the AP 190 is transmitting to the NCE 151, although the reverse could also be true (i.e., the NCE 151 transmitting to the AP 190). The S represents a sequence of training symbols, which are transmitting using a transmitter path through the transceiver 140. The transmitter path includes the transmitter (Tx) 210, the DAC 215, and the transmit beamformer 220. The channel 225 between the M_{T} antennas 141 and the M_{R} antennas 142 is modeled using H. The signals received at the antennas 142 are amplified by M_{R} voltages v 230. A receive path of the transceiver 145 includes in addition to the voltages 230, the receive combiner 240, an adder 245 an ADC 250 (producing the signal r) and the receiver 230, which produces the output signal y. It should also be noted that instead of the AP 190 transmitting to the NCE 151 in a backhaul scenario, the AP 190 could also be transmitting to the UE 110 in an access scenario.

For beam alignment, the transmit beamformer 220 is populated with entries from the omni-directional codebook 280, as described in detail below. The receiver (Rx) 260 determines, based on techniques described below, a narrow beam entry from the narrow beam codebook 290 to use. There is a feedback path 270, which is used to feedback an indication (e.g., an index into the codebook) of the narrow beam codebook entry to the AP 190, which the AP 190 then uses to populate the transmit beamformer 220 for future communication with the NCE 151. Although the omni-directional codebook 280 is only shown for the transmit beamformer 220, it could also be used at the receive combiner 240 for a joint transmit and receive combiner (beamformer) search as described below.

In the techniques described below, the codebooks 280/290 are assumed to be the same size. However, these codebooks 280/290 do not have to be the same size. It is also noted that in some embodiments, there could be an additional codebook for the receiver 260 so that the receiver 260 could limit its search of the possible receive beams (e.g., used to determine a codebook entry to use to populate the receive combiner 240).

One scalar antenna weight is applied with amplitude control. The system only supports, in an exemplary embodiment, one data stream with one DAC at the transmitter and one ADC at the receiver. The scalar channel output after receive combining is given by the following:

$$r [ n ] = \sqrt{ρ} {z}^{H} ( {\sum }_{l = 0}^{L - 1} {H}_{l} s [ n - l ] ) f + {z}^{H} n [ n ] , \qquad$$

where Hₗ ∈ C^{M}^{ᵣ}^{×M}^{_{T}} is l-th MIMO fading matrix in L multipaths (i.e., L channel rays), s[n] is the training symbol at time n, ρ is the signal-to-noise ratio, n[n]˜CN(0,I) is the additive white Gaussian noise vector, f=[f₁ f₂ . . . f_{M}_{_{T}}]^{T} is the transmit beamformer, and z=[z₁ z₂ . . . z_{M}_{_{R}}]^{T} is the receive combiner. It is assumed that ∥f∥₂=∥z∥₂=1 , and the effective channel seen by the receiver after transmit and receive beamforming is denoted by

$${z}^{H} ( {\sum }_{l = 0}^{L - 1} {H}_{l} ) f .$$

The slowly-fading broadband frequency-selective MIMO (multiple input, multiple output) channel is modeled by

$$H ( t ) = {\sum }_{l = 0}^{L - 1} {H}_{l} δ ( t - {τ}_{l} ) ,$$

where L is the total number of multipath rays, τₗ is the relative delay of the path l, and δ(t) is the Dirac delta function. Each MIMO channel matrix in the multipath channel is decomposed by array response vectors (the entries of the array response vector contain the phase values which correspond to a plane wave arriving from the given angle) and is given by

Hₗ=aᵣ(θₗ^{r})βₗaₜ^{T}(θₗ^{t}),

where βᵢ is the complex gain of the l-th ray, and M_{T}×1 aₜ(θₗ^{t}) and M_{R}×1 aᵣ(θₗ^{r}) are transmit and receive, respectively, array response vectors.

Examples for Beam Alignment

In beamforming sounding and training, the best beamforming pair (corresponding to the transmitter and receiver) which has the highest-gain beam pattern is selected. An exemplary embodiment herein utilizes omni-directional beam sounding patterns for constructing high-gain (e.g., narrow) beam patterns instead of exhaustively searching with narrow beams. The receiver listens to multiple sounding patterns, and estimates the received powers of high-gain beam patterns using the omni-directional sounding patterns as a basis. There are two types of sounding protocol, one-sided for transmit-beam construction and two-sided for transmit- and receive-beam construction. First, the omni-directional sounding pattern and construction of the high-gain (e.g., narrow) beams therefrom are described. The primary omni-directional beam pattern is designed with beam-spoiling (beam spoiling is a technique to choose the phases of the primary omni-directional beam so that the gain to all desired directions is minimized) techniques for minimizing the high-gain and obtaining non-fluctuating gain (i.e., a gain that does not vary much in all directions from a nominal gain such as 0 dB). Limiting the variation of the gain in all directions is what is meant by near-omni-direction beams in what follows. Note that for the algorithms considered here that whenever the term omni-directional is used it is really meant near omni-directional since truly omni-directional beams are nearly impossible to create for most arrays.

Beam Construction with Beam-Spoiling Techniques

The beamformed antenna pattern is written as the inner product between the array manifold vector at a given direction θ and antenna weight vector. The beam pattern associated with i-th codeword is given by

Bᵢ(θ)=wᵢ^{T}a_{(t,r)}(θ), 0≦θ≦π

Using the beam pattern, the power gain of the array is defined as Pᵢ(θ)=PₑM|Bᵢ(θ)|², where Pₑ is the transmit power. The power gain of the array quantifies the gain obtained by i-th codeword given the steering direction θ.

To assist in the beam alignment at both the transmitter and receiver, codebooks are typically used. A codebook is a set of predefined vectors (also called “entries” or “elements” herein) where each vector typically corresponds with a narrow beam where each vector's narrow beam would point to a different direction. For example, the codebook at the transmitter, [symbol] , could consist of N_{R} vectors f₁-f_{NR} and the codebook at the receiver, Z, could consist of N_{T} M_{T}×1 vectors zₗ-z_{NT}. In the following, it will be assumed that N_{T}=N_{R}=N, but in general the transmit and receive codebooks could contain a different number of vectors.

For the sake of the simplicity, in what follows, the algorithm is described by assuming M_{T}=M_{R}=M, [symbol] = [symbol] = [symbol] and N=M. As a first embodiment, consider a uniform linear array of M element at both the transmitter and receiver. The beam patterns can be steered with multiple phase values θᵢ (i=1, . . . , M) to cover the scanning beam area (e.g., physical azimuth angles from −90 to +90 degrees where 0 degrees is broadside to the array). The narrowband codebook could be designed by quantizing uniformly the set of possible angles: {θᵢ}_{i=1, . . . , M}=(2π/M). Given the assumption that the transmitter and receiver use the same codebook W={w₁, . . . , w_{M}}, each narrowband codeword is designed so that the codeword has a structure given by the following:

$${w}_{i} = {[ {w}_{i , 0} {w}_{i , 1} … {w}_{i , M - 1} ]}^{T}$$

$$with$$

$${w}_{i , m} = \frac{1}{\sqrt{M}} {e}^{- j m {θ}_{i}} .$$

As mentioned before, the use of the narrowband codebook in the beam alignment stage would create interference in undesired directions since the narrow beams would need to be scanned in all directions in order for the receiver to select the best one. Hence it is desired to create a primary omni-directional beam and then use M phase-shifted versions of the omni-directional beam as the omni-directional codebook. There are various methods for designing the primary omni-directional beam with one method being the aforementioned beam spoiling technique. Let the primary M×1 omni-directional beam be given by

p=[e^{-jφ}^{ᵢ}, . . . , e^{-jφ}^{_{M}}]^{T}.

where φᵢ is the phase value of the i^{th} element of p (e.g., the phase is found using the beam-spoiling technique). Then the omni-direction codebook can be created by phase-shifting p (i.e., multiplying the entries of p by phase values) as follows:

$${\overline{w}}_{i} = {[ {\overline{w}}_{i , 0} {\overline{w}}_{i , 1} … {\overline{w}}_{i , M - 1} ]}^{T}$$

$$with$$

$${\overline{w}}_{i , m} = \frac{1}{\sqrt{M}} {p}_{m} {e}^{- j m {θ}_{i}} ,$$

where pₘ is the m^{th} entry of p. Assuming p can be expressed with the phase values above, the omni-directional codebook can be expresses as:

$${\overline{w}}_{i} = {[ {\overline{w}}_{i , 0} {\overline{w}}_{i , 1} … {\overline{w}}_{i , M - 1} ]}^{T}$$

$$with$$

$${\overline{w}}_{i , m} = \frac{1}{\sqrt{M}} {e}^{- j ( m {θ}_{i} + {φ}_{m} )} ,$$

with {θᵢ}_{i=1, . . . , M}=i(2π/M).

Note that there are many methods to achieve omni-directional beam patterns. The example presented follows the beam-broadening method and spoiled phase values in D. Lawrence, “Low Probability of Intercept Antenna Array Beamforming,” IEEE Transactions on Antennas and Propagation, September 2010. Note that in the above example the primary omni-directional beam is phase-only. However the primary omni-direction beam can be phase and gain values as well.

In another embodiment a 2-D array can be used such as the rectangle array. In this case the total number of antennas can be expressed as M=MₐMₑ where Mₐ is the number of antennas in the azimuth direction and Mₑ is the number of elements in the elevation direction. In this case the primary omni-direction beam can be expressed as:

$$p = [ [ {e}^{- j {φ}_{1}} , … , {e}^{- j {{φ}_{M}}_{a}} ] {e}^{- j {γ}_{1}} , [ {e}^{- j {φ}_{1}} , … , {e}^{- j {{φ}_{M}}_{a}} ] {e}^{- j {γ}_{2}} , … … , {[ {e}^{- j {φ}_{1}} , … , {e}^{- j {{φ}_{M}}_{a}} ] {e}^{- j {γ}_{{M}_{e}}} ]}^{T} .$$

The design of the primary omni-directional beam for the rectangular array case can be performed similarly to the linear array case by separately finding an omni-directional beam in each direction (azimuth and elevation). In other words omni-directional beams can be found for both of the following assuming a linear array:

pₐ=[e^{-jφ}^{ᵢ}, . . . , e^{-jφ}^{_{Ma}}]^{T} and pₑ=[e^{-jγ}^{₁}, . . . , e^{-jγ}^{_{Me}}]^{T}.

Note that pₐ can be thought of as a first primary omni-directional beam in the azimuth direction and that pₑ can be thought of as a second primary omni-directional beam in the elevation direction.
The omni-directional codebook for the rectangular array can then be given as:

$${\overline{w}}_{i} = {[ {\overline{w}}_{i , 0} {\overline{w}}_{i , 1} … {\overline{w}}_{i , M - 1} ]}^{T}$$

$$with$$

$${\overline{w}}_{i , m} = \frac{1}{\sqrt{M}} {e}^{- j ( {( m )}_{{M}_{a}} {θ}_{i} + {φ}_{{( m )}_{{M}_{a}}} )} {e}^{- j ( ⌊ m / {M}_{e} ⌋ {\overline{ω}}_{l} + {γ}_{⌊ m / {M}_{e} ⌋ } )} ,$$

where (m)_{M} means m modulus M, [x] means the largest integer less than or equal to x, and θᵢ and ωₗ are given as:

$${θ}_{i} = \frac{2 π i}{{M}_{a}} and {θ}_{l} = \frac{2 π l}{{M}_{e}} ,$$

with i=0, . . . , M−1 and l=0, . . . , Mₑ−1. As in the linear array case the primary omni-directional beam can be phase-only as given above or can have entries that have differing gains and phases.

The relation between two types of beam patterns, high-gain beams and omni-directional beams, is given as follows. A high-gain (e.g., narrow) beam is created via a linear combination of the omni-directional beams. Each high-gain beam is constructed from the omni-directional beams as follows:

$${w}_{0} = {c}_{0 , 0} {\overline{w}}_{0} + {c}_{0 , 1} {\overline{w}}_{1} + … + {c}_{0 , M - 1} {\overline{w}}_{M - 1}$$

$${w}_{1} = {c}_{1 , 0} {\overline{w}}_{0} + {c}_{1 , 1} {\overline{w}}_{1} + … + {c}_{1 , M - 1} {\overline{w}}_{M - 1}$$

$$⋮$$

$${w}_{M - 1} = {c}_{M - 1 , 0} {\overline{w}}_{0} + {c}_{M - 1 , 1} {\overline{w}}_{1} + … + {c}_{M - 1 , M - 1} {\overline{w}}_{M - 1} .$$

Manipulating the linear equations, the construction coefficients c_{i,j}. are calculated by the following (where the superscript “−1” means matrix inversion):

$$[ \begin{matrix}{c}_{0 , 0} & {c}_{1 , 0} & … & {c}_{M - 1.0} \\ {c}_{0 , 1} & {c}_{1 , 1} & … & {c}_{M - 1 , 1} \\ {c}_{0 , 2} & {c}_{1 , 2} & … & {c}_{M - 1 , 2} \\ ⋮ & & ⋱ & ⋮ \\ {c}_{0 , M - 1} & {c}_{1 , M - 1} & … & {c}_{M - 1 , M - 1}\end{matrix} ] = {[ \begin{matrix}1 & 1 & … & 1 \\ {e}^{j {φ}_{1}} & {e}^{j ( {φ}_{1} + {θ}_{1} )} & … & {e}^{j ( {φ}_{1} + {θ}_{M - 1} )} \\ {e}^{j {φ}_{2}} & {e}^{j ( {φ}_{2} + {θ}_{2} )} & … & {e}^{j ( {φ}_{2} + {θ}_{2 ( M - 1 )} )} \\ ⋮ & & ⋱ & ⋮ \\ {e}^{j {φ}_{M - 1}} & {e}^{j ( {φ}_{M - 1} + {θ}_{M - 1} )} & … & {e}^{j ( {φ}_{M - 1} + {θ}_{( M - 1 ) ( M - 1 )} )}\end{matrix} ]}^{- 1} [ \begin{matrix}1 & 1 & … & 1 \\ 1 & {e}^{j {θ}_{1}} & … & {e}^{j {θ}_{M - 1}} \\ 1 & {e}^{j {θ}_{2}} & … & {e}^{j {θ}_{2 ( M - 1 )}} \\ ⋮ & & ⋱ & ⋮ \\ 1 & {e}^{j {θ}_{M - 1}} & … & {e}^{j {θ}_{M - 1 ) ( M - 1 )}}\end{matrix} ] .$$

Transmit Beam Construction

The omni-directional sounding methodology will be applied to beam alignment for the goal of transmit beamforming. The M omni-directional patterns are known at both transmit and receive sides, and all M sounding beams are transmitted to the receiver side. Based-on the received signals transmitted from multiple omni-directional sounding beams, the desired high-gain beam is constructed by linear combinations of the omni-directional beam (codewords). The signals transmitted from the omni-directional beams could be sequences of symbols (i.e., pilots symbols) known by both the transmitter and receiver. However, before the transmit beamformer can be determined, receiver combining should be performed to ensure the highest possible signal strength from the signals received from the transmitter. In one embodiment the best receive beamformer is found separately from the transmit beamformer and thus the search for the transmit beamformer is separate from the receive beamformer. In another embodiment the different possible receive beamformers are applied to the received signals sent from the omni-directional beams. Using receive combining vector zⱼ, which is steered in the j-th beam direction, then the receiver 260 receives rᵢ^{(j)}=zⱼ^{H}Hₛ w̅ᵢ+zⱼ^{H}n, where

$${H}_{s} = {\sum }_{l = 0}^{L - 1} {H}_{l} .$$

The transmitter 210 sends sequences of symbols using all of the omni-directional beams for each received beam direction. Thus all of the omni-directional beams are scanned on all of the received steering vectors zⱼ(j=1, . . . , M).

For each receive beam zⱼ, the the received signal power, ρⱼ, of the best transmit beam is selected by comparing all constructed high-gain beams. Let \hat{n}ⱼ represent the best transmit beam at receive beam j, which is given by the following:

$$\begin{matrix}{ρ}_{j} = {max}_{n} {\vert {\sum }_{i = 0}^{M - 1} {c}_{n , i} {r}_{i}^{( j )} \vert}^{2} \\ {max}_{n} {\vert {\sum }_{i = 0}^{M - 1} {c}_{n , i} {z}_{j}^{H} {H}_{s} {\overline{w}}_{i} {c}_{n , i} {z}_{j}^{H} n \vert}^{2}\end{matrix}$$

$${\hat{n}}_{j} = {arg max}_{n} {\vert {\sum }_{i = 0}^{M - 1} {c}_{n , i} {r}_{i}^{( j )} \vert}^{2} .$$

At the end of sweeping, the receiver compares the power of the received signal ρⱼ to select the best pair of receive/transmit beams. This pair is calculated by the following:

$$\hat{j} = {arg max}_{j} {ρ}_{j} .$$

The aligned transmit beamformer 220 and receive combiner 240 which maximize the received signal power is obtained by the following:

$$\hat{f} = {w}_{\hat{n}} = {\sum }_{i} {c}_{{\hat{n}}_{\hat{j}} , i} {\overline{w}}_{i}$$

$$\hat{z} = {z}_{\hat{j}} .$$

At this point the receiver can either feed back to the transmitter the coefficients cₙ to describe \hat{f} or the receiver can feed back an indication (e.g., codebook index) of the narrowband codeword (e.g., entry in the narrowband codebook) \hat{f}. It should be noted that besides the codebook index, other indications could be possible. For example for the linear array, the indication could be the direction, θ, quantized to a number of bits. In this way the number of quantized levels could be thought of as the size of the narrowband codebook. For the rectangular array the indication could be the quantized directions θₐ and θₑ for the azimuth and elevation dimensions respectively.

Joint Transmit and Receive Beam Construction

The method of transmit beamforming construction is easily extended to joint transmit and receive omni-directional beamforming. The receiver combines the received signal with omni-directional beam patterns instead of high-gain scanning beams. As in the previous one-sided beamforming method, M omni-directional patterns are sent M times. However, the receiver 260 then combines M² received sounding beam patterns. The signal r_{(i,j)}= w̅_{hu H} H̅ₛ w̅ᵢ+ w̅ⱼ^{H} n is received. The best beam pair is selected by comparing all combinations of beams, which is given by the following:

$$\begin{matrix}( \hat{m} , \hat{n} ) = {arg max}_{m , n} {\vert {\sum }_{j = 0}^{M - 1} {\sum }_{i = 0}^{M - 1} {c}_{m , j} {c}_{n , i} {r}_{( i , j )} \vert}^{2} \\ = {arg max}_{m , n} {\vert {\sum }_{j = 0}^{M - 1} {\sum }_{i = 0}^{M - 1} {c}_{m , j} {c}_{n , i} {\overline{w}}_{j}^{H} {H}_{s} {\overline{w}}_{i} + {c}_{m , j} {c}_{n , i} {\overline{w}}_{j}^{H} n \vert}^{2} .\end{matrix}$$

The transmit and receive beam patterns are constructed by a linear combination which is given by the following:

$$\hat{f} = {w}_{\hat{n}} = {\sum }_{i} {c}_{\hat{n} , i} {\overline{w}}_{i}$$

$$\hat{z} = {w}_{\hat{m}} = {\sum }_{i} {c}_{\hat{m} , j} {\overline{w}}_{j} .$$

Similar to the above case, the receiver 260 can either feed back to the transmitter 260 the coefficients c_{\hat{m},j} to describe \hat{f} or the receiver 260 can feed back a codebook index of the narrowband codeword \hat{f}.

Additional Codebook Design and Other Examples

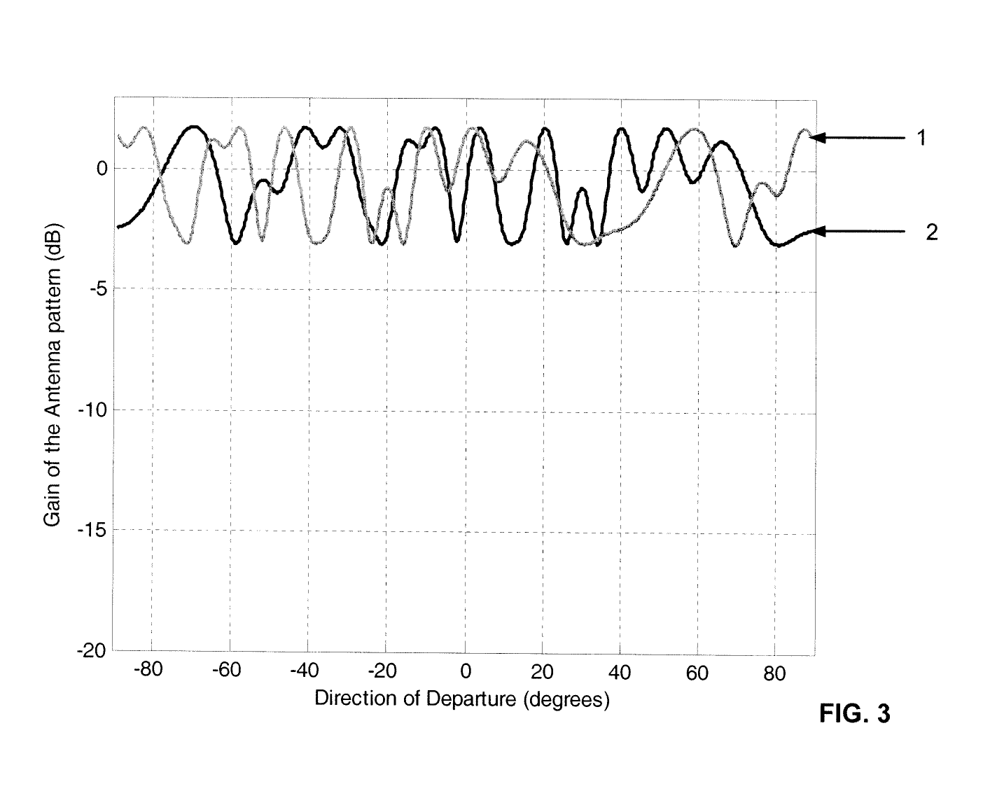

As stated above, in an exemplary embodiment, near-omni-directional beams are used with multiple phase-shifted versions to enable a codebook-based beam search algorithm to find the best narrow beam codebook index with omni-directional beam transmissions. For example, an N=32-element codebook would use 32 shifted copies of the primary omni-directional beam (e.g., 2 of the 32 codebook entries shown FIG. 3). FIG. 3 is an example showing two shifted omni-directional beams used for codebook design. That is, two example omni-directional codebook beams 1 and 2 are shown for a 16 element ULA (uniform linear array) antenna. Each beam is a shifted version of each other. If one shifts beam 1 a positive 50 degrees, the shifted version of beam 1 will be the same as beam 2. Similarly, if one shifts beam 2 a negative 50 degrees, the shifted version of beam 2 will be the same as beam 1. These beams are near-omni-directional meaning that the beams do not favor one particular direction with a strong peak and do not vary too far from 0 dB (as allowed by the physics of the antenna arrays) for all azimuth angles. For 2-D arrays like the abovementioned rectangular array, the near omni-directional would not have a strong peak in any one given direction and would no vary too far from 0 dB. Note that for the algorithms considered here whenever the term omni-directional is used it is really meant near omni-directional. One may use N different shifts of an omni-direction beam to create a codebook of size N.

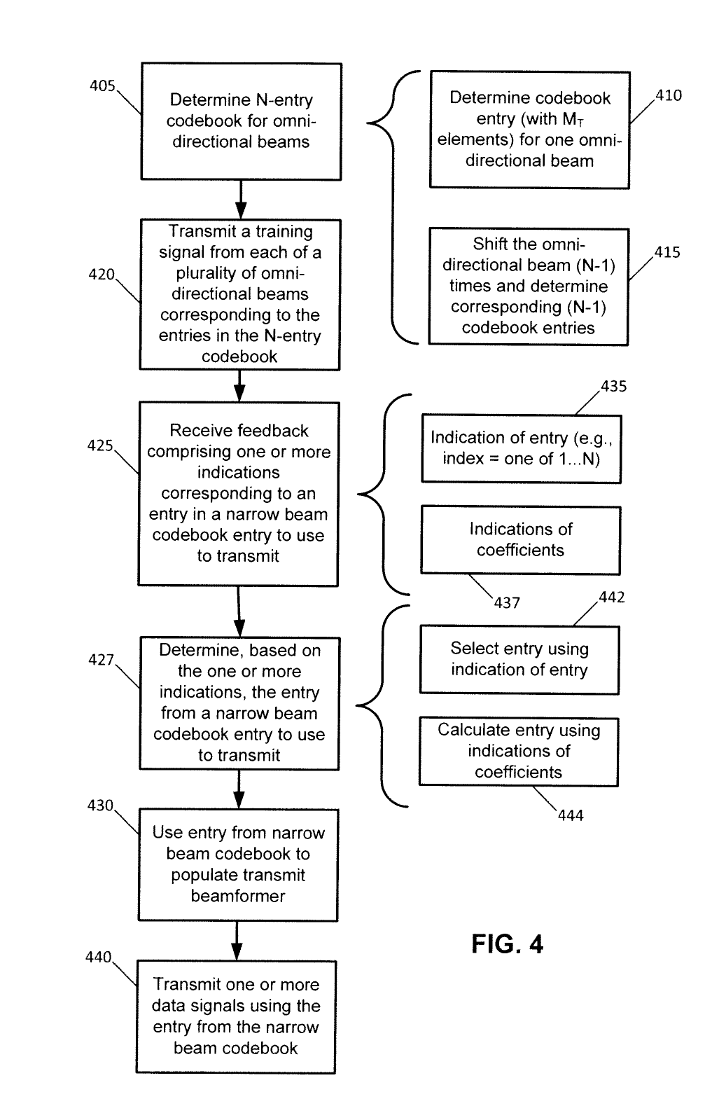

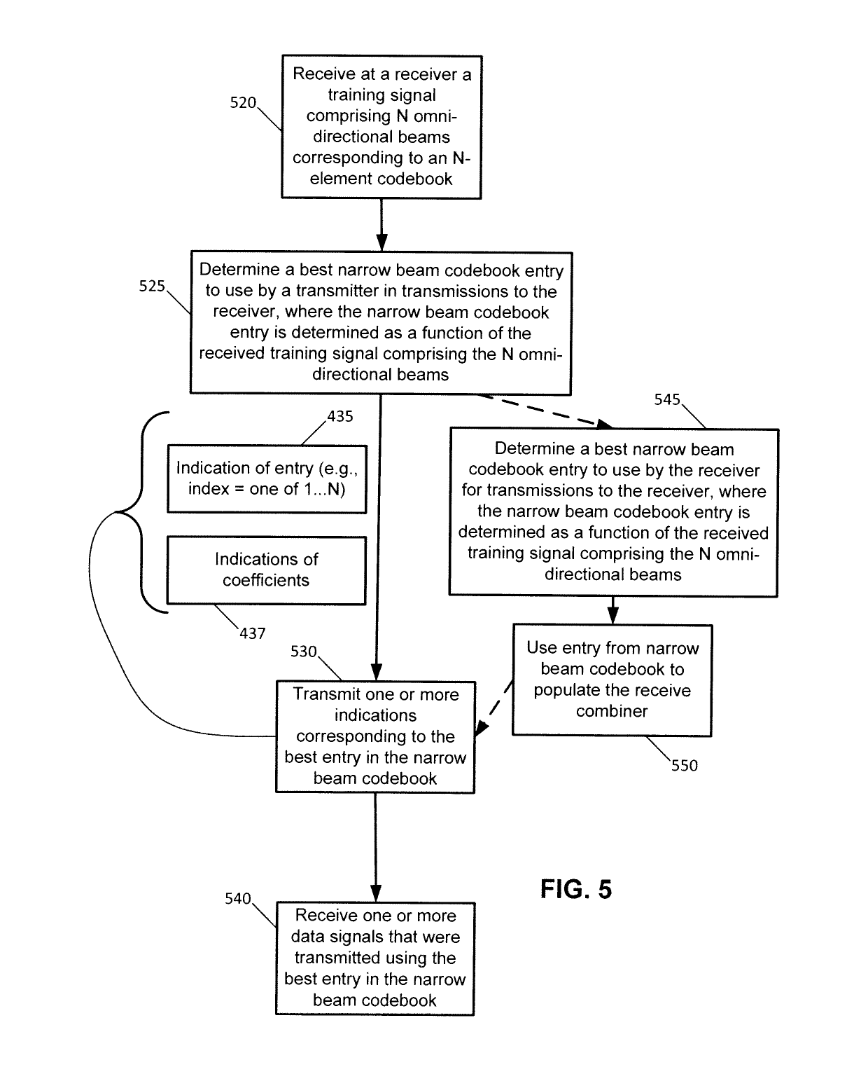

Referring now to FIG. 4, a block diagram is shown of a flowchart performed by a transmitter (e.g., 210) of a beam alignment method utilizing omni-directional sounding and use thereof. The flowchart may be performed by computer program code (e.g., 153/173) executed by one or more processors (e.g., 150/175), may be performed by hardware (e.g., as physical elements in an integrated circuit configured to perform one or more of the blocks or a portion of a block), or may be performed by some combination of computer program code executed by one or more processors and hardware. In the examples of FIGS. 4 and 5, it is assumed the AP 190 acts as the device transmitting the omni-directional beams and the NCE 151 acts as the device receiving the omni-directional beams, but this is merely for ease of exposition. In fact the NCE 151 could be the transmitting device and the AP 190 could be the receiving device, the AP 190 could be the transmitting device and the UE 110 could be the receiving device, or the UE 110 could be the transmitting device and the AP 190 could be the receiving device.

In block 405, the AP 190 determines an N-entry codebook 280 for omni-directional beams. In an exemplary embodiment, the N-entry codebook 280 may be determined by determining a codebook entry (with M_{T} elements) for one omni-directional beam (block 410) which could be the primary omni-directional beam and then shifting the omni-directional beam (N−1) times and determining corresponding (N−1) codebook entries (block 415). The determining of the omni-directional codebook 280 need not be done in real time, instead the codebook 280 could be precomputed and storied in a memory unit (e.g., memories 155).

In block 420, the AP 190 transmits a training signal (also called a pilot signal) from each of a plurality of omni-directional beams corresponding to the entries in the N-entry codebook 280. In block 425, the AP 190 receives feedback comprising one or more indications corresponding to a (e.g., best) narrow beam codebook entry from the narrow beam codebook 290 to use to transmit. The one or more indications can be an indication 435 (e.g., an index=one of 1 to N) of the entry. As another example (block 437), the one or more indications can be indications of the coefficients cₙ or c_{\hat{m},j}. In block 427, the AP 190 determines, based on the one or more indications, the entry from a narrow beam codebook entry to use to transmit. In one example, this is performed by (block 442) selecting the entry based on the indication of the entry (e.g., using the index to select the entry from the codebook 290). In another example, this is performed (block 444) by calculating the entry using the indications of the coefficients. These calculations have been described above.

In block 430, the AP 190 uses the entry from the narrow beam codebook 290 to populate the transmit beamformer 220. For example, the elements in the entry are used to populate the transmit beamformer 220. In block 440, the AP 190 transmits one or more data signals using the entry from the narrow beam codebook 290.

Turning to FIG. 5, a block diagram is shown of a flowchart performed by a receiver (e.g., 260) of a beam alignment method utilizing omni-directional sounding and use thereof. The flowchart may be performed by computer program code (e.g., 153/173) executed by one or more processors (e.g., 150/175), may be performed by hardware (e.g., as physical elements in an integrated circuit configured to perform one or more of the blocks or a portion of a block), or may be performed by some combination of computer program code executed by one or more processors and hardware.

In block 520, the NCE 151 receives (e.g., at a receiver 260) a training signal comprising N omni-directional beams corresponding to an N-element omni-directional codebook 280. In block 525, the NCE determines a best narrow beam codebook entry (e.g., from narrow beam codebook 290) to use by a transmitter in transmissions to the receiver, where the narrow beam codebook entry is determined as a function of the received training signal comprising the N omni-directional beams. This is described above in detail.

In block 530, the NCE 151 transmits one or more indications corresponding to the best entry in the narrow beam codebook 290. In an example, the one or more indications can be indication 435 (e.g., an index=one of 1 to N) of the entry. As another example (block 437), the one or more indications can be indications of the coefficients cₙ or c_{\hat{m},j}. In block 540, the NCE 151 receives one or more data signals that were transmitted using the best narrow beam codebook entry.

In block 545, the NCE 151 may also determine a best narrow beam codebook entry to use by the receiver for transmissions to the receiver, where the narrow beam codebook entry is determined as a function of the received training signal comprising the N omni-directional beams. That is, the NCE 545 determines a narrow beam codebook entry used to populate (block 550) the receive combiner 240.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memory 125, 155, 175 or other device) that may be any media or means that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein is to utilize omni-directional beams for beam alignment.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
transmitting using a plurality of antennas a training signal from each of N omni-directional beams corresponding to N entries in an omni-directional codebook;
receiving feedback comprising one or more indications corresponding to an entry from a narrow beam codebook entry to use to transmit;
determining, based on the one or more indications, the entry from a narrow beam codebook entry to use to transmit; and
transmitting using the plurality of antennas a data signal using the entry from the narrow beam codebook.

2. The method of claim 1, wherein:
the one or more indications comprise an index into the narrow beam codebook; and
determining further comprises selecting the entry based on the index.

3. The method of claim 1, wherein:
the one or more indications comprise a plurality of indications corresponding to coefficients; and
determining further comprises calculating the entry using the plurality of indications corresponding to the coefficients.

4. The method of claim 1, wherein the N entries in the omni-directional codebook correspond to N−1 phase shifts of at least one primary omni-directional beam and an entry corresponding to the at least one primary omni-directional beam.

5. The method of claim 4, wherein the at least one primary omni-directional beam is a single primary omni-directional beam.

6. The method of claim 4, wherein the at least one primary omni-directional beam comprises a first primary omni-directional beam in an azimuth direction and a second primary omni-directional beam in an elevation direction.

7. The method of claim 5, wherein each of the at least one primary omni-directional beams is designed using a beam spoiling technique.

8. The method of claim 1, wherein transmitting further comprises transmitting the data signal using a narrow beam corresponding to the entry from the narrow beam codebook, and wherein narrow beams corresponding to entries in the narrow beam codebook are created using linear combinations of the N omni-directional beams corresponding to the N entries in the omni-directional codebook.

9. A computer program product comprising a computer-readable storage medium bearing computer program code embodied therein for use with a computer, the computer program code comprising code for performing the method of claim 1.

10. A method, comprising:
receiving at a receiver using a plurality of antennas a training signal comprising N omni-directional beams corresponding to N entries in an omni-directional codebook;
determining a best entry from a narrow beam codebook to use by a transmitter in transmissions to the receiver, where the best entry is determined as a function of the received training signal comprising the N omni-directional beams; and
transmitting to the transmitter one or more indications corresponding to the best entry of the narrow beam codebook.

11. The method of claim 10, wherein:
determining further comprises determining an index that corresponds to the entry of the narrow beam codebook; and
the one or more indications comprise an index into the narrow beam codebook.

12. The method of claim 10, wherein:
determining further comprises determining a plurality of coefficients that correspond to the entry into the narrow beam codebook; and
the one or more indications comprise a plurality of indications corresponding to the plurality of coefficients.

13. The method of claim 10, wherein determining further comprises determining signals corresponding to narrow beams by using the N omni-directional beams, each of the narrow beams corresponding to an entry in a narrow beam codebook, and using the determined signals to determine the best entry.

14. The method of claim 13, wherein the N entries in the omni-directional codebook correspond to N−1 phase shifts of at least one primary omni-directional beam and an entry corresponding to the at least one primary omni-directional beam.

15. The method of claim 14, wherein the at least one primary omni-directional beam is a single primary omni-directional beam.

16. The method of claim 14, wherein the at least one primary omni-directional beam comprises a first primary omni-directional beam in an azimuth direction and a second primary omni-directional beam in an elevation direction.

17. The method of claim 15, wherein each of the at least one primary omni-directional beams is designed using a beam spoiling technique.

18. The method of claim 10, further comprising determining a receive combining set of weights using the received training signal comprising the N omni-directional beams in conjunction with the best entry in the narrow beam codebook.

19. The method of claim 10, wherein narrow beams corresponding to entries in the narrow beam codebook are created using linear combinations of the N omni-directional beams corresponding to the N entries in the omni-directional codebook.

20. A computer program product comprising a computer-readable storage medium bearing computer program code embodied therein for use with a computer, the computer program code comprising code for performing the method of claim 10.
